(19) United States
(12) Patent Application Publication
(10) Pub. No.: US 2002/0071935 A1
(43) Pub. Date: Jun. 13, 2002

(54) Passive element solder pad free of solder ball

(76) Inventor: Chi-Chuan Wu, Taichung (TW)

Correspondence Address: BACON & THOMAS, 4th Floor, 625 Slaters Lane, Alexandria, VA, 22314, US

(21) Appl. No.: 09/757,597

(22) Filed: Jan. 11, 2001

(30) Foreign Application Priority Data
Dec. 12, 2000 (CN) 89126404

(51) Int. Cl. B32B 3/10

(52) U.S. Cl. 428/134

(57) ABSTRACT

A passive element solder pad structure free of solder balls includes a substrate which has an upper surface disposed with a plurality of solder pads and a layer of solder mask. The solder mask has a radial-shaped opening which has a relatively large space in the center and a plurality of grooves extended outward from the center. The opening enables the surface of the solder pads partly or totally exposed. When printing the solder pad for reflow process to solder passive elements on the substrate, solder paste contact area between the passive element and solder pad will be increased for enhancing adhering force whereby to prevent the passive element from separating from the substrate. The opening space also may prevent excess molten solder paste from spilling to the surface of the solder mask and prevent solder balls from forming on the solder mask surface.

### FIELD OF THE INVENTION

This invention relates to a passive element solder pad structure and particularly a solder pad structure that is capable of preventing solder ball from forming in the process of surface mount technology.

### BACKGROUND OF THE INVENTION

The growing popularity of personal electronic products in recent years such as Personal Digital Assistant (PDA), mobile phone and the like has generated very high demand on product functionality, speed and reliability. These requirements are especially tight for high frequency electronic or communication products. There is a constant pressure to make the products slim and light. It is now a common requirement to integrate the passive elements such as resistors and capacitors with the IC chip in the electronic packaging process to form a semiconductor package for enhancing product integrity. Furthermore, Surface Mount Technology (SMT) has becomes a mature and stable technique at present. All this has made electronic package of passive element and IC chip becomes slimmer and lighter.

The process of employing conventional SMT for soldering passive elements to a substrate will be described hereunder by referring to FIGS. 1A and 1B. First, prepare a substrate 1 with an upper surface 11; then dispose a plurality of solder pads 2 and a layer of solder mask 3 on the upper surface 11, the solder mask 3 has a plurality of openings 31 to expose the surface of the solder pads 2; print the surface of the solder pads 2 with a layer of solder paste 4; pick and place a passive element 5 on the top of the solder paste 4 and align the contact point 51 of the passive element 5 against the solder paste 4; use soldering reflow technique to melt the solder paste 4 under the aid of a flux; dispose the contact point 51 of the passive element 5 on the molten solder paste 4 whereby the passive element 5 will be soldered to the solder pad 2 and establish electrical connection therebetween when the solder paste 4 is solidified.

There are generally two types of solder pad 2 for soldering passive element 5. One is Solder Mask Defined (SMD) type (shown in FIG. 2) which has an opening 31 formed on the solder mask 3 that is smaller size than the solder pad 2 for exposing a portion of the surface of the solder pad 2. Another one is Non-Solder Mask Defined (NSMD) type (shown in FIG. 3) in which the opening 31 has a larger size than the solder pad 2 for completely exposing the solder pad 2. At the center section of one lateral side of the solder pad 2, there is a conductive trace 6 to link the solder pad 2 with a chip (not shown in the figures). However during performing the reflow process, the amount of solder paste 4 applying on the surface of the solder pad 2 is difficult to control. Too little solder paste 4 will cause weak adhesion between the passive element 5 and solder pad 2. Too much solder paste 4 (as shown in FIGS. 4A and 4B), the filling space between the passive element 5 and solder pad 2 could be not enough and might result in overflow of excess solder paste 4 through the opening 31 to the surface of the solder mask 3 and form solder balls 7 thereon after solidified (shown in FIG. 4C). Hence after the passive element 5 has been soldered to the solder pad 2, it needs additional work to inspect and clear the solder balls 7. It is a tedious process to completely remove the solder balls 7 and will result in additional production time and cost.

If the solder balls 7 have not been completely removed before proceeding subsequent manufacturing processes, serious problems might ensue. For instance, in the molding process, when filling the molds with encapsulation such as epoxy resin for encasing the chip and passive element 5, the solder balls 7 which have relatively weak adhesion force might be impacted by the pouring resin and result in displacement. The dislocating solder balls 7 could hit the bonding wire and cause the Au wire, Cu wire or Al wire removed from their solder point and become open. This could cause short circuit and damage the entire circuitry and impact final production yield.

### SUMMARY OF THE INVENTION

In view of aforesaid disadvantages, it is therefore an object of this invention to provide a passive element solder pad structure that has more space to accommodate the molten solder paste during reflow process whereby to prevent the solder balls from forming.

Another object of this invention is to provide more contact surface between the solder pad and solder paste to produce a wetting effect for forming a stronger bonding force between the passive element and solder pad, and enhancing the conductivity.

In one aspect, the structure according to this invention is formed on a substrate surface and includes a plurality of solder pads and a layer of solder mask which has a radial-shaped opening formed therein. The radial-shaped opening has a larger area in the center portion and a plurality of ditch-like grooves extended radially outward from the center portion. The surface of the solder pad may be exposed partly or completely through the opening. Because of such a design, the contact area between the solder paste and solder pad is expanded. Hence when doing the reflow process for soldering the passive elements to the substrate, the adhesion force between the two will be greatly increased and may prevent the passive element from separating from the substrate. Moreover, because this invention provides more space for filling and flowing of the solder paste, it will effectively reduce the spilling of excess molten solder paste or formation of solder balls.

### BRIEF DESCRIPTION OF THE DRAWINGS

The invention, as well as its many advantages, may be further understood by the following detailed description and drawings, in which:

FIG. 1A and 1B are schematic sectional views of a conventional substrate soldered with passive elements.

FIG 2 is a schematic top view of a conventional SMD type solder pad.

FIG. 3 is a schematic top view of a conventional NSMD type solder pad.

FIG. 4A, 4B and 4C are schematic sectional views of a conventional technique, showing passive elements being soldered to a substrate and forming solder balls.

FIG. 5A is a schematic top view of a SMD type solder pad of this invention.

FIG. 5B is a schematic sectional view of a SMD type solder pad of this invention.

FIG. 6A is a schematic top view of a NSMD type solder pad of this invention.

FIG. 6B is a schematic sectional view of a NSMD type solder pad of this invention.

FIG. 7 is a schematic top view of an embodiment of this invention.

FIG. 8 is a schematic top view of another embodiment of this invention.

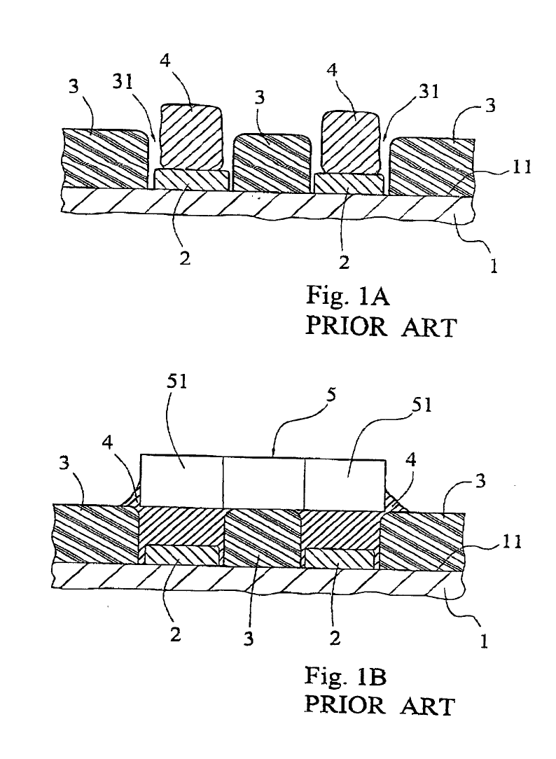

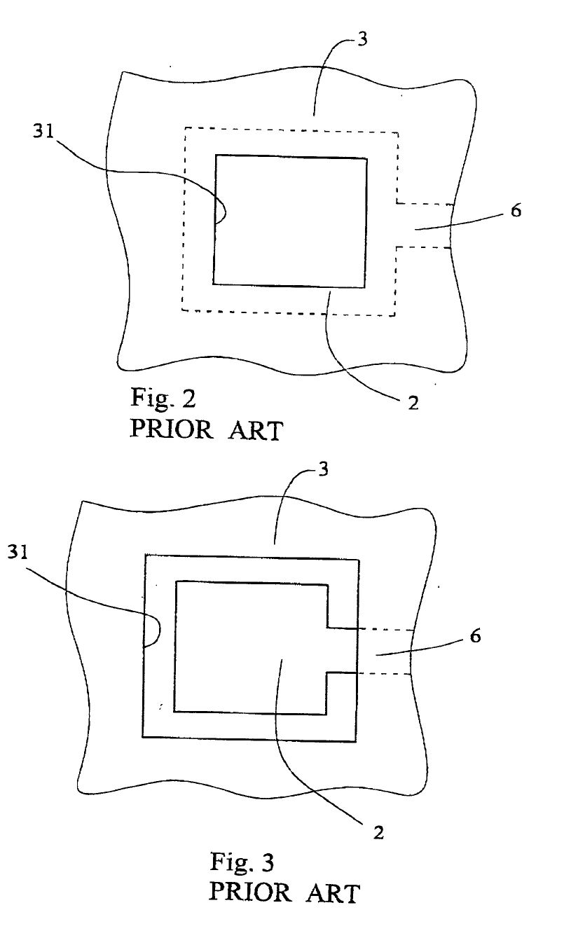

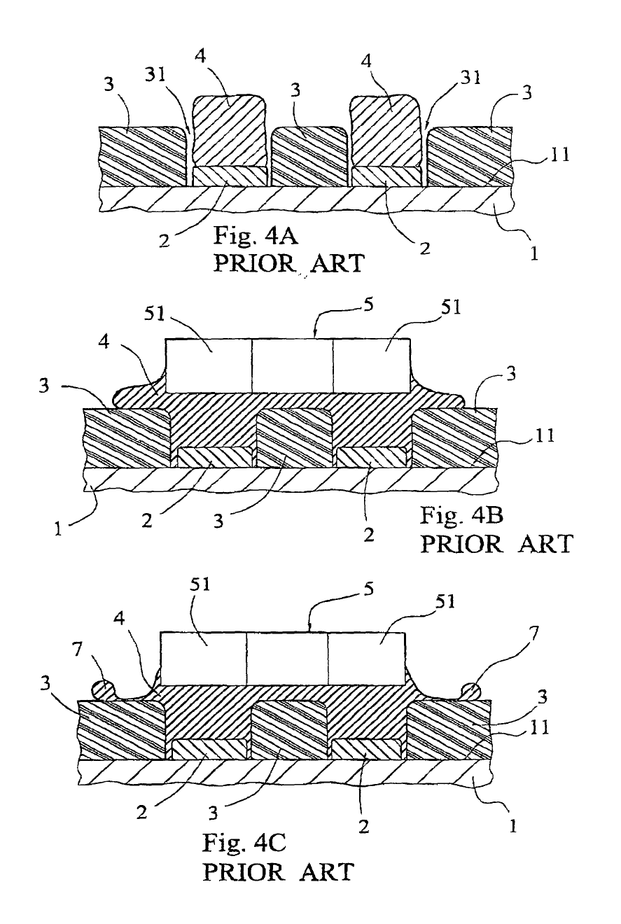

### DESCRIPTION OF THE PREFERRED EMBODIMENTS

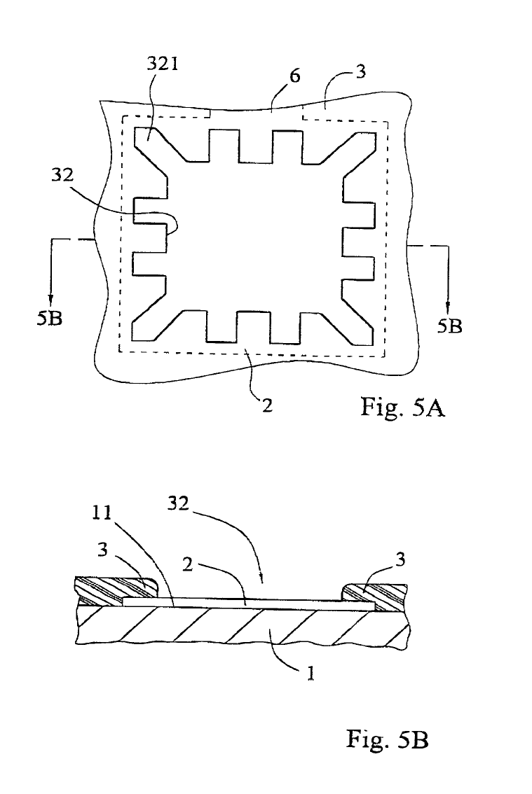

Referring to FIGS. 5A and 5B for this invention adapted to a SMD type solder pad, a substrate 1 is provided which has an upper surface 11. On the upper surface 11, there are disposed with a solder pad 2 and a solder mask 3. The solder pad 2 is made of copper. The solder mask 3 is formed from a layer of photosensitive material such as polyimide or ultraviolet (UV)-curable resin. The solder mask 3 has a radial-shaped opening 32 which enables the top surface of the solder pad 2 exposed. The radial-shaped opening 32 is formed by exposure and development process used in photolithography technique known in the art. The top surface area of the solder pad 2 is larger than the radial-shape opening 32, hence a portion of the periphery area of the solder pad 2 is covered by the solder mask 3, whereby form a SMD type solder pad 2. The center portion of the radial-shaped opening 32 is rectangular as customarily adapted. At one side of the solder pad 2, there is a conductive trace 6 extended outward. In the opening 32, there are a plurality of ditch-like grooves 321 radially extended outward from the side edges of the rectangular portion. Referring to FIG. 5B, the top surface of the solder pad 2 has a lower height level than the top surface of the solder mask 3. Hence the top surface of the solder pad 2 and the peripheral edges of the opening 32 and grooves 321 form a closed containing space at a selected height. Because of such a design, during the reflow process, the molten solder paste 4 held in the opening 32 will flow and spread to the grooves 321 to fully cover the opening 32 and grooves 321 whereby to form a secured soldering between the passive element 5 and solder pad 2. Excess molten solder paste 4 will be contained in the grooves 321 without spilling over to the top surface of the solder mask 3, and may prevent the solder ball 7 from forming on the top surface of the solder mask 3. As a result, subsequent manufacturing processes may be done smoothly and efficiently with better quality

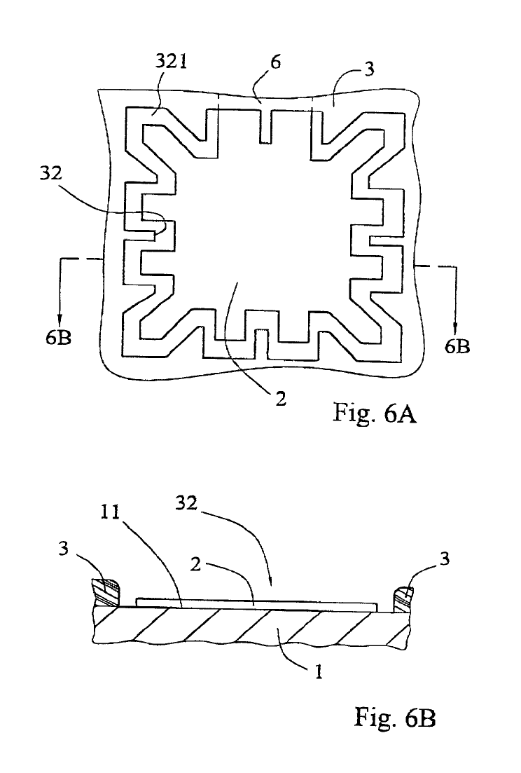

FIGS. 6A and 6B show this invention adapted for a NSMD type solder pad. The solder pad 2 is formed in a radial-shaped contour on an upper surface 11 of a substrate 1 and has a conductive trace 6 extended outward from one side thereof. On the upper surface 11 of the substrate 1, there is also a solder mask 2 formed by photolithography process and has a radial-shape opening 32 which is generally shaped like the solder pad 2 but has a larger size than the solder pad 2. The radial-shaped opening 32 surrounds the solder pad 2 and exposes the top surface thereof. The center portion of the radial-shaped opening 32 is rectangular as customarily adapted. In the opening 32, there is a plurality of ditch-like grooves 321 radially extended outward from the side edges of the rectangular portion. Referring to FIG. 6B, the top surface of the solder pad 2 is at a lower height level than the top surface of the solder mask 3. Hence the top surface of the solder pad 2 and the peripheral edges of the opening 32 and grooves 321 form a closed containing space at a selected height. Furthermore, the peripheral edges of the solder pad 2 and the side edges of the opening 32 form an additional tortuous groove (unmarked) on the upper surface 11. Because of such a design, during the reflow process, the molten solder paste 4 held in the opening 32 will flow and spread to the grooves 321 to fully cover the opening 32 and grooves 321 and tortuous groove whereby to form an even more secured soldering between the passive element 5 and solder pad 2 than the one shown in FIGS. 5A and 5B. Excess solder paste 4 will be contained in the grooves 321 without spilling over to the top surface of the solder mask 3, and may prevent the solder ball 7 from forming on the top surface of the solder mask 3.

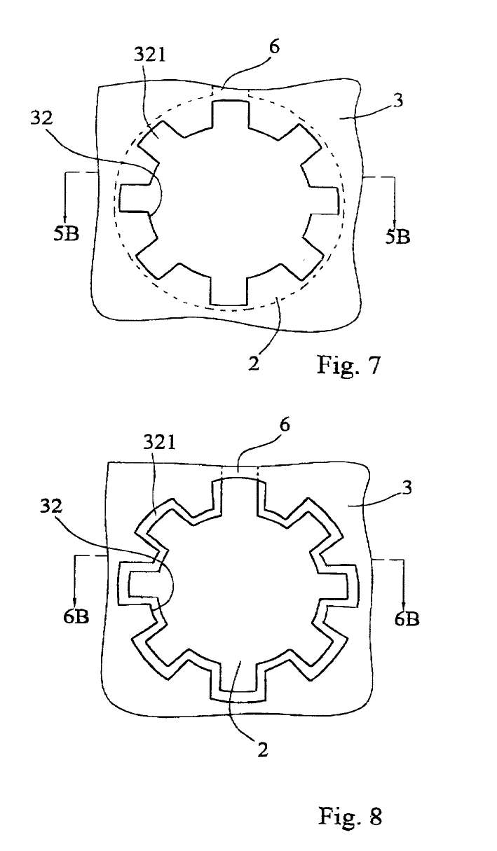

FIG. 7 shows an embodiment of this invention which is adapted to a SMD type solder pad 2 and is constructed based on the principle illustrated in FIGS. 5A and 5B. The solder pad 2 has a circular contour and a conductive trace 6 extended outward from one end thereof. A solder mask 3 which has an opening 32 formed in the center is superposed on the top surface of the solder pad 2. The opening 32 may be formed in a selected pattern desired In this embodiment, it is formed with a circular center portion and a plurality of radial ditch-like grooves 321 extended outward. The opening 32 has a smaller size than the solder pad 2 and is laid over the solder pad 2 within the peripheral boundary of the solder pad 2. When employing the reflow process to solder the passive element 5 to the solder pad 2, the molten solder paste 4 held in the center portion of the opening 32 will disperse into the grooves 321 rapidly. This will help to speed up the soldering process. As a result, total manufacturing process efficiency will also be improved. FIG. 8 depicts another embodiment of this invention adapted to a NSMD type solder pad. The solder pad 2 has a circular center portion and a plurality of arms extended radially outward from the center portion. The solder mask 3 is superposed on the solder pad 2 and also has an opening 32 formed by photolithography process in a shape like the solder pad 2 but has a larger size to fully expose the solder pad 2. All other features and process are substantially same as the one shown in FIGS. 6A and 6B.

In summary, this invention provides an opening in the solder mask that has a relatively large center portion and has a plurality of radial grooves extended outward from the center portion. It thus has more soldering space and solder paste flowing channels than the conventional solder pad structure and may result in more secured solder bonding force between the passive element and the solder pad. The added opening space can contain more solder paste, therefore may prevent molten solder paste from spilling or forming solder ball. The enlarged soldering surface may further enhance conductive surface between the passive element and solder pad whereby improving conductivity between the two. The forming of the opening in the solder mask uses photolithography process which is same as the conventional process, only the shape or pattern is different. Hence this invention may be adapted easily without affecting regular and total process.

It may thus be seen that the objects of the present invention set forth herein, as well as those made apparent from the foregoing description, are efficiently attained. While the preferred embodiments of the invention have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A passive element solder pad free of solder ball comprising:
a substrate having an upper surface and a lower surface;
a plurality of solder pads located on the upper surface of the substrate; and
a solder mask superposed on the solder pads having a plurality of radial-shaped openings to expose all the solder pad surface, the radial-shaped opening having a relatively large center portion and a plurality of grooves extended outward from the periphery of the center portion.

2. The passive element solder pad of claim 1, wherein the solder mask is made from a photosensitive material including polyimide or ultraviolet-curable resin.

3. The passive element solder pad of claim 1, wherein the solder pads are made of copper.

4. The passive element solder pad of claim 1, wherein the openings are formed by coating a layer of polyimide or ultraviolet-curable resin on the surface of the substrate and solder mask, and performing photolithography process thereon.

5. The passive element solder pad of claim 1, wherein the solder pad has a top surface which has a lower height level than that of the solder mask.

6. The passive element solder pad of claim 1, wherein the center portion is substantially rectangular and the openings have a plurality of grooves extended outward from the peripheral edges of the center portion.

7. The passive element solder pad of claim 1, wherein the center portion is substantially circular and the openings have a plurality of grooves extended outward from the peripheral edge of the center portion.

8. The passive element solder pad of claim 1, wherein the solder pad has a rectangular area in the center thereof and a plurality of arms extended outward from the peripheral edges thereof.

9. The passive element solder pad of claim 1, wherein the solder pad has a circular area in the center thereof and a plurality of arms extended outward from the peripheral edge thereof.

10. A passive element solder pad free of solder ball, comprising:
a substrate having an upper surface and a lower surface;
a plurality of solder pads located on the upper surface of the substrate; and
a solder mask superposed on the solder pads having a plurality of radial-shaped openings to partly expose the solder pad surface, the radial-shaped opening having a relatively large center portion and a plurality of grooves extended outward from the periphery of the center portion.

11. The passive element solder pad of claim 10, wherein the solder mask is made from a photosensitive material including polyimide or ultraviolet-curable resin.

12. The passive element solder pad of claim 10, wherein the solder pads are made of copper.

13. The passive element solder pad of claim 10, wherein the opening is formed by coating a layer of polyimide or ultraviolet-curable resin on the surface of the substrate and solder mask, and performing photolithography process thereon.

14. The passive element solder pad of claim 10, wherein the solder pad has a top surface which has a lower height level than that of the solder mask.

15. The passive element solder pad of claim 10, wherein the center portion is substantially rectangular and the opening has a plurality of grooves extended outward from the peripheral edges of the center portion.

16. The passive element solder pad of claim 10, wherein the center portion is substantially circular and the opening has a plurality of grooves extended outward from the peripheral edge of the center portion.
